(19) United States
(12) Patent Application Publication
(10) Pub. No.: US 2013/0306245 A1
(43) Pub. Date: Nov. 21, 2013

(54) Tire Bead Breaking Tool and Method for Using the Same

(71) Applicants: Michael White, Montgomery City, MO (US); Rob Jensen, Clarks Grove, MN (US); Rob Kochie, Dodge Center, MN (US)

(72) Inventors: Michael White, Montgomery City, MO (US); Rob Jensen, Clarks Grove, MN (US); Rob Kochie, Dodge Center, MN (US)

(73) Assignee: Service Solutions U.S. LLC, Wilmington, DE (US)

(21) Appl. No.: 13/476,491

(22) Filed: May 21, 2012

(51) Int. Cl. B60C 25/132; B23P 11/00; B32B 37/14

(52) U.S. Cl. 157/1.17; 156/60; 29/428

(57) ABSTRACT

A tire bead breaking tool is provided. The tire bead breaking tool may include a handle portion and a breaker portion. The breaker portion may include a joint portion configured to couple to the handle portion, a curved portion configured to handle external impacts from a plurality of angles and a chisel portion configured to be driven between a tire and a wheel in order to break a tire bead.

### FIELD OF THE INVENTION

The present invention relates generally to a tool. More particularly, the present invention relates to a tire bead breaking tool that assists in breaking a tire bead when dismounting a tire from a wheel rim.

### BACKGROUND OF THE INVENTION

Tire bead is an edge of a tire that engages a groove in a metal rim the wheel. When tires are properly inflated, the air pressure within the tire keeps in the groove of the metal rim. Special tools are often used in dismounting tires from the metal rim of wheels. Tires can be difficult to dismount from the metal rims because usually the tire bead is held in a groove on the metal rim.

Also, new types of tires have been developed and deployed in recent years including low profile and the so-called “run flat” tires. These new types of tires are becoming more and more common. They often have extremely rigid and stiff side walls which may be difficult to dismount from the metal rim of the wheel, using traditional tools and methods.

In the past, most tire rims were made of steel and were fairly resistant or forgiving to tool marks being made on the metal rim as a traditional tool was used to dismount the tire from the metal rim. However, many modern wheels are made of aluminum or of steel with a chrome or other decorative coating. In any event, these more modern wheels are likely to appear scuffed, scratched or even be bent when placed in contact with the traditional tools.

In addition, traditional tools for dismounting a tire from the metal rim of a wheel, oftentimes, do not have sufficient rigidity and cannot withstand great force from external impacts. Furthermore, traditional tools may require a user to hold the tool within close proximity to the point of external impacts and which is often undesirable. Therefore, it is desirable to provide a tool that can be used in assisting dismounting a tire from a metal rim in view of the new modern tires which may have extremely stiff and rigid side walls and the likelihood of damaging the modern wheels. Also, it is desirable to provide a tool that can withstand harsh external impacts.

### SUMMARY OF THE INVENTION

The foregoing needs are met, to a great extent, by the present invention, wherein in one aspect, an apparatus is provided that in some embodiments a tool is provided that assists in breaking a tire bead from a tire of a wheel rim even when a tire is a low profile and/or a run flat tire, having extremely rigid and stiff side walls.

In accordance with one embodiment of the present disclosure, a tire bead breaking tool is provided. The tire bead breaking tool may include a handle portion and a breaker portion. The breaker portion may comprise a joint portion configured to couple to the handle portion, a curved portion configured to handle external impacts from a plurality of angles, and a chisel portion configured to be driven between a tire and a wheel in order to break a tire bead.

In accordance with another embodiment of the present disclosure, a method of manufacturing may also be provided. The method may include: providing a handle portion; and providing a breaker portion. The break portion comprises a joint portion configured to couple to the handle portion, a curved portion configured to handle external impacts from a plurality of angles and a chisel portion configured to be driven between a tire and a wheel in order to break a tire bead.

In accordance with another embodiment of the present disclosure, a tire bead breaker is provided. The tire bead breaking tool includes means for grasping and means for breaking. The means for breaking includes means for joining configured to couple to the means for grasping, means for impacting configured to handle external impacts from a plurality of angles, and means for chiseling configured to be driven between a tire and a wheel in order to break a tire bead.

In accordance with yet another embodiment of the present invention, a tire bead locking tool is provided. The tool may include: a body; a first means for gripping connected to the body; a second means for gripping pivotally connected to the body and located to oppose the first means for gripping; a means for locking configured to selectively lock the first and second means for gripping in a relative position with respect to each other; and a resilient member attached to one of the first and second means for gripping and located between the first and second means for gripping.

There has thus been outlined, rather broadly, certain embodiments of the invention in order that the detailed description thereof herein may be better understood, and in order that the present contribution to the art may be better appreciated. There are, of course, additional embodiments of the invention that will be described below and which will form the subject matter of the claims appended hereto.

In this respect, before explaining at least one embodiment of the invention in detail, it is to be understood that the invention is not limited in its application to the details of construction and to the arrangements of the components set forth in the following description or illustrated in the drawings. The invention is capable of embodiments in addition to those described and of being practiced and carried out in various ways. Also, it is to be understood that the phraseology and terminology employed herein, as well as the abstract, are for the purpose of description and should not be regarded as limiting.

As such, those skilled in the art will appreciate that the conception upon which this disclosure is based may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

### BRIEF DESCRIPTION OF THE DRAWINGS

FIG. 1 is a perspective view illustrating an exemplary tire bead breaking tool in accordance with the present disclosure.

FIG. 2 is a side view of an exemplary tire bead breaking tool as illustrated in FIG. 1 in accordance with the present disclosure.

FIG. 3 is a perspective view of an exemplary tire bead seating tool attached to a wheel rim showing a tire partially installed on the wheel rim in accordance with the present disclosure.

FIG. 4 is a perspective view of another exemplary tire bead seating tool in accordance with the present disclosure.

FIG. 5 is a perspective view of another exemplary tire bead seating tool in accordance with the present disclosure.

### DETAILED DESCRIPTION

The various embodiments in accordance with the present invention will now be described with reference to the drawing figures, in which like reference numerals refer to like parts throughout. An embodiment in accordance with the present invention provides a tire bead breaking tool 100.

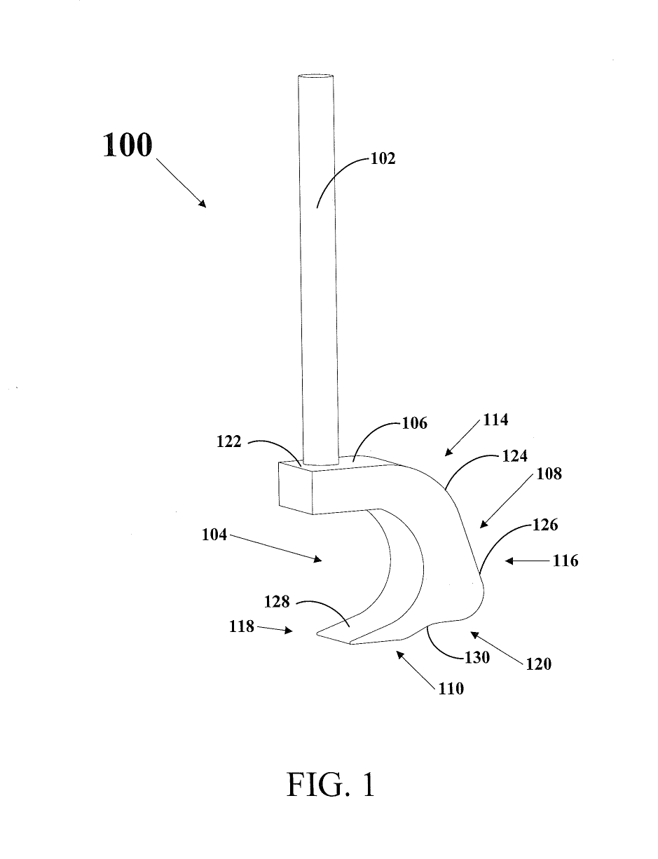

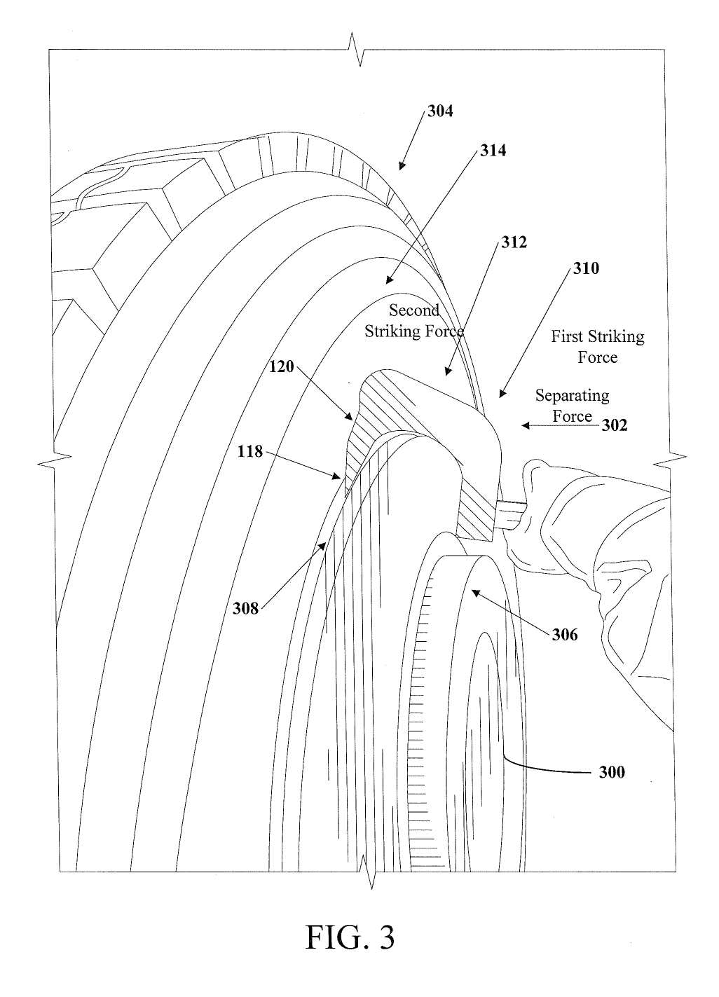

As shown in FIG. 1, the tire bead breaking tool 100 includes a handle portion 102 and a breaker portion 104. The handle portion 102 may be composed of an elongated cylindrical metal rod that may fit in the hand of a user. The breaker portion 104 includes a joint portion 106, a curved portion 108 and a chisel portion 110. The breaker portion 104 may have a substantially U-shape to efficiently drive the breaker portion 104 between a tire and a metal rim of the wheel in order to break the tire bead. The breaker portion 104 may be attached to the handling portion 102 via the joint portion 106. For example, the joint portion 106 may comprise a flat surface 122 having a substantially uniform thickness to attach to the handle portion 102. The flat surface 122 of the joint portion 106 may allow a user to efficiently and uniformly apply a force to push a tire from away from the metal rim of the wheel (shown in FIG. 3).

The curved portion 108 may extend from the joint portion 106 and include a plurality of striking portions 114 and 116 having a plurality of striking surfaces 124 and 126. The plurality of striking surfaces 124 and 126 may allow for external impacts delivered by, for example, a hammer at different angles in order to efficiently drive the tire bead breaking tool 100 between a tire and a metal rim of a wheel.

In an exemplary embodiment, the curved portion 108 may comprise a first striking portion 114 having a first striking surface 124 at a first angle and a second striking portion 116 having a second striking surface 126 at a second angle. The first striking portion 114 and the second striking portion 116 may have a thickness that may withstand repeated external impacts (e.g., via a hammer) in order to drive the tire bead breaking tool 100 between a tire and a metal rim of a wheel. The first striking portion 114 may be curved and extending from the joint portion 106. Also, the first striking surface 124 of the first striking portion 114 may be curved.

The first striking portion 114 may have a variable thickness. In an exemplary embodiment, the thickness of the first striking portion 114 may increase as the first striking portion 114 extends away from the joint portion 106. The second striking portion 116 may be substantially flat and extend from the first striking portion 114. Also, the second striking surface 126 of the second striking portion 116 may be substantially flat. The second striking portion 116 may have a variable thickness. In an exemplary embodiment, the thickness of the second striking portion 116 may increase as the second striking portion 116 extends away from the first striking portion 114.

The chisel portion 110 may extend from the curved portion 108. The chisel portion 110 may comprise a blade portion 118 and a sidewall portion 120. The blade portion 118 may comprise a sharp edge 128 that may be easily driven between a tire and a metal rim of the wheel. The sidewall portion 120 may comprise a notch 130 that may conform to the curvature of the sidewall of a tire. The sidewall portion 120 may allow an efficiently transfer of force apply by the user to push the sidewall of a tire away from a metal rim of a wheel.

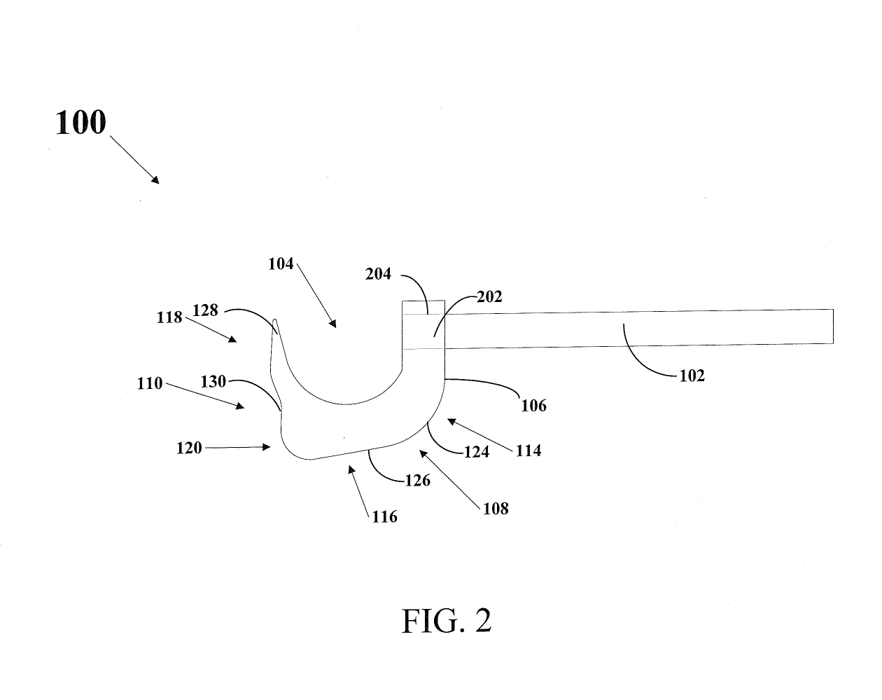

FIG. 2 is a side view of an exemplary tire bead breaking tool 100 as illustrated in FIG. 1 in accordance with the present disclosure. The handle portion 102 may be composed of an elongated cylindrical metal rod that may fit in the hand of a user. The handle portion 102 may have a sufficient length so that when a user holds the tire bead breaking tool 100, the user's hand may be located at a predetermined distance from the breaker portion 104 and thus the plurality of striking portions 114 and 116. The length of the handle portion 102 may be selected to provide a desirable distance between the plurality of striking portions 114 and 116 and the user's hand when the user applies external pressure (e.g., hammer) to the plurality of striking portions 114 and 116.

In an exemplary embodiment, the handle portion 102 and the breaker portion 104 may be formed of a single piece of metal material. In another exemplary embodiment, the joint portion 106 may comprise a hole 202 configured to receive the handle portion 102. The hole 202 may receive an end portion 204 of the handle portion 102 in order to join the handle portion 102 and the breaker portion 104. The end portion 204 of the handle portion 102 may be joined to the breaker portion 104 by welding, screw thread, fastener, press fit or any other joining method.

FIG. 3 illustrates a usage of an exemplary tire bead breaking tool 100 in accordance with the present disclosure. A separating force 302 may be applied by a user via the handle portion 102 of the tire bead breaking tool 100. For example, the user may push the tire bead breaking tool 100 against the tire and apply the separating force 302 in order to push the tire from the metal rim 306 of the wheel. The sidewall portion 120 of the tire bead breaking tool 100 may be dimensioned to correspond to a sidewall 314 of a tire 304 mounted on a metal rim 306 of a wheel 300. The separating force 302 applied by the user may be efficiently transferred from the handle portion 102 to the sidewall portion 120. The sidewall portion 120 may push back the sidewall 314 of the tire 304 to create an opening 308 between the tire 304 and the metal rim 306 of the wheel 300.

The blade portion 118 of the tire bead breaking tool 100 may be inserted into the opening 308 between the tire 304 and the metal rim 306 of the wheel 300. A first striking force 310 may be applied via an external impact (e.g., via a hammer) to a first striking portion 114. The first striking force 310 may push the side wall 314 of the tire 304 further back to enlarge the opening 308 between the tire 304 and the metal rim 308 of the wheel 300. Also, the first striking force 310 may drive the blade portion 118 deeper into the opening 308 between the tire 304 and the metal rim 308 of the wheel 300.

A second striking force 312 may be applied via an external impact (e.g., via a hammer) to the second striking portion 116. The second striking force 312 may drive the blade portion 118 deeper into the opening 308 between the tire 304 and the metal rim 306 in order to break the tire bead. The tire bead breaking tool 100 may be used at different portions of the tire 304 and the metal rim 306 in order to break the tire bead.

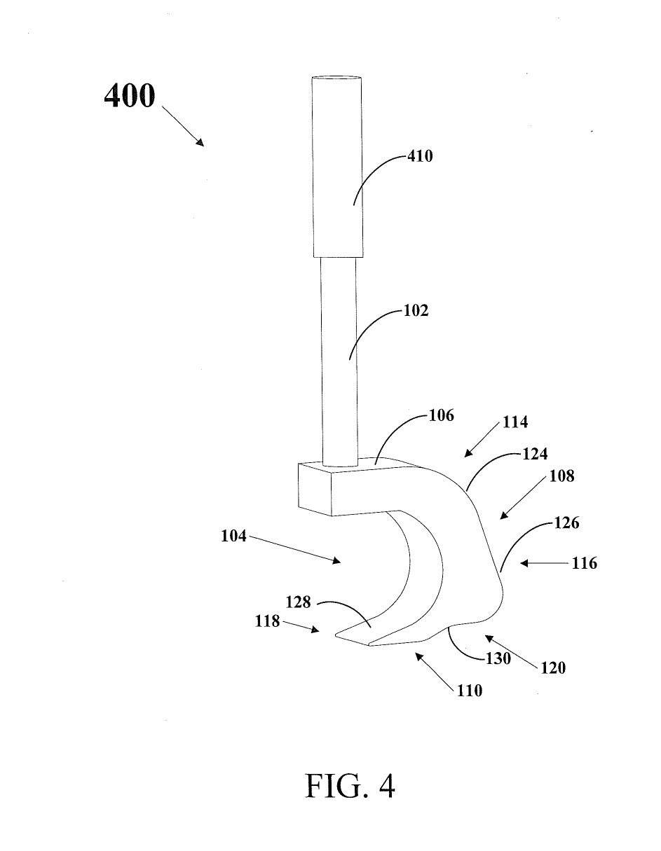

FIG. 4 is a perspective side view illustrating an exemplary tire bead breaking tool 400 in accordance with the present disclosure. The tire bead breaking tool 400 illustrated in FIG. 4 is similar to the tire bead breaking tool 100 illustrated in FIG. 1, except that the handle portion 102 may comprise a coating layer 410 that may improve a grip by the user of the handle portion 102. The coating layer 410 may be composed of a resilient material that may provide comfort to the user. The coating layer 410 may be composed of a plastic material, a rubber material, a polymer material or any other material that may increase a friction of the handle portion 102 and thus improves a grip by the user. The thickness of the coating layer 410 may vary depending on a comfort of the user.

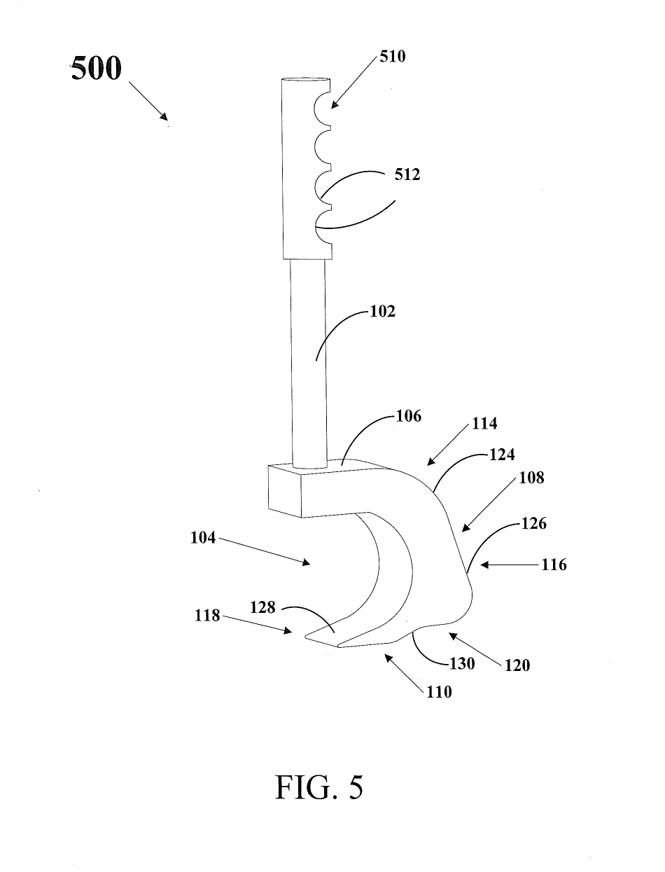

FIG. 5 is a perspective side view illustrating another exemplary tire bead breaking tool 500 in accordance with the present disclosure. The tire bead breaking tool 500 illustrated in FIG. 5 is similar to the tire bead breaking tool 100 illustrated in FIG. 1, except that the handle portion 102 may comprise a plurality of handle grooves 512 that may be dimensioned corresponding to the shape of the fingers of a user. The plurality of handle grooves 512 may be formed on one side of the handle portion 102 in order to improve the grip by a user of the handle portion 102. Also, a coating layer 510 having the plurality of handle grooves 112 may be implemented on the handle portion 102.

The many features and advantages of the invention are apparent from the detailed specification, and thus, it is intended by the appended claims to cover all such features and advantages of the invention which fall within the true spirit and scope of the invention. Further, since numerous modifications and variations will readily occur to those skilled in the art, it is not desired to limit the invention to the exact construction and operation illustrated and described, and accordingly, all suitable modifications and equivalents may be resorted to, falling within the scope of the invention.

What is claimed is:

1. A tire bead breaking tool comprising:
a handle portion; and
a breaker portion that comprises:
a joint portion configured to couple to the handle portion;
a curved portion configured to handle external impacts from a plurality of angles; and
a chisel portion configured to be driven between a tire and a wheel in order to break a tire bead.

2. The tire bead breaking tool of claim 1, wherein the handle portion comprises a coating layer in order to improve a grip of the handle portion.

3. The tire bead breaking tool of claim 1, wherein the handle portion comprises a plurality of handle grooves that are dimensioned to correspond to a shape of fingers of a user.

4. The tire bead breaking tool of claim 1, wherein the joint portion comprises a hole configured to receive the handle portion.

5. The tire bead breaking tool of claim 1, wherein the joint portion comprises a flat surface having a substantially uniform thickness to attach to the handle portion.

6. The tire bead breaking tool of claim 1, wherein the handle portion is joined to the breaker portion by welding, screw thread, fasteners, or press fit.

7. The tire bead breaking tool of claim 1, wherein the breaker portion have a substantially U-shape.

8. The tire bead breaking tool of claim 1, wherein the curved portion is extended from the joint portion.

9. The tire bead breaking tool of claim 1, wherein the curved portion comprises a plurality of striking portions having a plurality of striking surfaces.

10. The tire bead breaking tool of claim 9, wherein the plurality of striking surfaces comprise a first striking surface having a first angle and a second a second striking surface having a second angle.

11. The tire bead breaking tool of claim 9, wherein the plurality of striking portions comprise a first striking portion that is curved and extending from the joint portion and a second striking portion extending from the first striking portion.

12. The tire bead breaking tool of claim 11, wherein the first striking portion has a variable thickness and the thickness of the first striking portion increases as the first striking portion extends away from the joint portion.

13. The tire bead breaking tool of claim 11, the second striking portion is substantially flat and extend from the first striking portion and the second striking surface of the second striking portion is substantially flat.

14. The tire bead breaking tool of claim 1, wherein the chisel portion comprises a blade portion and a sidewall portion.

15. The tire bead breaking tool of claim 14, wherein the blade portion comprises a sharp edge.

16. The tire bead breaking tool of claim 14, the sidewall portion comprises a notch that is dimensioned to correspond to a curvature of a sidewall of the tire.

17. A method of manufacturing a tire bead breaking tool comprising:
providing a handle portion; and
providing a breaker portion that comprises:
a joint portion configured to couple to the handle portion;
a curved portion configured to handle external impacts from a plurality of angles; and
a chisel portion configured to be driven between a tire and a wheel in order to break a tire bead.

18. The method of claim 17, wherein the handle portion is joined to the breaker portion by welding, screw thread, fasteners, or press fit.

19. The method of claim 17, wherein the curved portion comprises a plurality of striking portions having a plurality of striking surfaces.

20. A tire bead breaking tool comprising:
means for grasping; and
means for breaking comprises:
means for joining configured to couple to the means for grasping;
means for impacting configured to handle external impacts from a plurality of angles; and
means for chiseling configured to be driven between a tire and a wheel in order to break a tire bead.
